(19) United States
(12) Patent Application Publication
(10) Pub. No.: US 2010/0220045 A1
(43) Pub. Date: Sep. 2, 2010

(54) DISPLAY DEVICE

(76) Inventors: Kenichi AKIYAMA, Mobara (JP); Mitsuru Goto, Yokohama (JP); Norimitsu Nishikawa, Mobara (JP); Uki Tsuchiyama, Mobara (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/780,209

(22) Filed: May 14, 2010

Related U.S. Application Data
(62) Division of application No. 11/438,327, filed on May 23, 2006.

(30) Foreign Application Priority Data
May 25, 2005 (JP) 2005-151959

(51) Int. Cl. G09G 3/36

(52) U.S. Cl. 345/98

(57) ABSTRACT

In a display device, profile emphasizing is performed without using a frame memory while realizing the further reduction of power consumption. A display device includes a display panel provided with a plurality of pixels each of which has a pixel electrode, and a drive circuit which supplies a video signal to the respective pixels through video lines. Here, the drive circuit includes a profile emphasizing circuit which generates profile emphasizing display data which emphasizes a profile in response to display data inputted from the outside and emphasizes a profile portion of an image to be displayed on the display panel, and a memory which stores the profile emphasizing display data. The profile emphasizing circuit includes a latch circuit which sequentially stores continuous k (k≧2) pieces of display data in display data for 1 display line and an arithmetic circuit which generates the profile emphasizing display data based on the k pieces of display data stored in the latch circuit.

### CLAIM OF PRIORITY

This application is a divisional of application Ser. No. 11/438,327, filed on May 23, 2006, now pending, which claims the benefit of Japanese Application No. 2005-151959, filed May 25, 2005 in the Japanese Patent Office, the disclosures of which are incorporated herein by reference.

### BACKGROUND OF THE INVENTION

1. Field of the Invention

The present invention relates to a display device, and more particularly to a technique which is effectively applicable to a drive circuit of a liquid crystal display device used in a mobile phone or the like.

2. Description of the Related Art

A TFT (Thin Film Transistor) type liquid crystal display module which includes a miniaturized liquid crystal display panel in which the number of sub pixels is 240×320×3 in color display has been popularly used as a display part of a portable equipment such as a mobile phone (see following patent documents 1, 2).

With respect to contents of a recent mobile phone, a motion picture is handled in many cases and mobile phones compatible to TV broadcasting is increased.

Accordingly, recent mobile phones are requested to enhance a motion picture display function. Such image processing is performed by a CPU (see following patent document 3).

Here, as prior art documents relevant to the present invention, followings are named.

[Patent Document 1] Japanese Patent Laid-open 2004-61892

[Patent Document 2] Japanese Patent Laid-open 2004-240235

[Patent Document 3] Japanese Patent Laid-open 2002-278522

### SUMMARY OF THE INVENTION

In a liquid crystal display module which is used as a display part of a mobile phone or the like, as a method for enhancing a motion picture display performance, it is effective to emphasize an edge portion of a display image by adopting a profile emphasizing technique.

However, in a conventionally known profile emphasizing technique, there has been a drawback that a frame memory is necessary for comparison with a previous frame and the mounting of the frame memory on a driver of a miniaturized liquid crystal display module is difficult.

The liquid crystal display module which is used as a display part of a mobile phone or the like includes, to reduce the power consumption, a semiconductor memory (Static Random Access Memory: hereinafter referred to as SRAM). However, to take the battery driving into consideration, there exists strong demand for further reduction of power consumption.

The present invention has been made to overcome the above-mentioned drawbacks of the related art and it is an object of the present invention to provide a technique which, in the display device, can realize the further reduction of power consumption and, at the same time, can emphasize a profile without using a frame memory.

The above-mentioned and other objects and novel features of the present invention will become apparent based on the description of this specification and attached drawings.

To briefly explain typical inventions among the inventions disclosed in this specification, they are as follows.

To achieve the above-mentioned object, the present invention is directed to a display device which includes a display panel provided with a plurality of pixels each of which has a pixel electrode, and a drive circuit which supplies a video signal to the respective pixels through video lines, wherein the drive circuit includes a profile emphasizing circuit which generates profile emphasizing display data which emphasizes a profile in response to display data inputted from the outside and emphasizes a profile portion of an image to be displayed on the display panel, a memory which stores the profile emphasizing display data, and the profile emphasizing circuit includes a latch circuit which sequentially stores continuous k (k≧2) pieces of display data in display data for 1 display line and an arithmetic circuit which generates the profile emphasizing display data based on the k pieces of display data stored in the latch circuit.

Further, according to the present invention, the kth display data in the k pieces of display data is fetched into the latch circuit at a point of time that a voltage level of a latch pulse is changed from a first voltage level to a second voltage level, and the remaining display data in the k pieces of display data are fetched into the latch circuit at a point of time that the voltage level of the latch pulse is changed from the second voltage level to the first voltage level.

Further, according to the present invention, the display device includes a pulse generating circuit which generates the latch pulse based on a write strobe signal, and the pulse generating circuit generates the latch pulse based on the write strobe signal inputted previously when the write strobe signal is not inputted.

Further, the present invention is directed to a display device which includes a display panel provided with a plurality of pixels each of which includes a pixel electrode, a drive circuit which supplies a video signal to the respective pixels through video lines, and a counter electrode which faces pixel electrodes of the respective pixels, and a power source circuit which applies a common voltage to the counter electrode, and is driven by alternately inverting an electric field direction between the pixel electrodes and the counter electrode alternately for a predetermined cycle, wherein the display device includes a first switching element which is connected between the counter electrode and the power source circuit, a second switching element which is connected between the video line and the drive circuit, and a third switching element and a fourth switching element which are connected in series between the video line and the counter electrode, wherein the first switching element, the second switching element and the third switching element respectively include an n-type transistor element, and the fourth switching element is constituted of a p-type transistor element.

Here, in a first period of the predetermined cycle, the first switching element and the second switching element are turned off and the third switching element is turned on, and in a second period of the predetermined cycle, the first switching element and the second switching element are turned on and the third switching element is turned off.

Further, to the fourth switching element, a voltage equal to or larger than a highest voltage out of the common voltage is applied as a substrate potential, and a voltage which prevents a negative potential from being generated at a terminal to which the third switching element is connected is applied as a gate potential.

Further, according to the present invention, in a third period between the first period and the second period of the predetermined cycle, the first switching element, the second switching element and the third switching element are turned off, and in a third period of the predetermined cycle, a first intermediate voltage which is lower than a highest voltage out of the common voltage or a second intermediate voltage which is higher than a lowermost voltage out of the common voltage and is lower than the first intermediate voltage is alternately applied to the counter electrode.

Further, the predetermined cycle is changeable for every display region of the display panel.

To briefly explain advantageous effects obtained by the typical inventions among the inventions disclosed in this specification, they are as follows.

According to the display device of the present invention, it is possible to emphasize a profile without using a frame memory while acquiring the further reduction of the power consumption.

### BRIEF DESCRIPTION OF DRAWINGS

FIG. 1 is a block diagram showing the schematic constitution of a liquid crystal display module of an example of the present invention;

FIG. 2 is a block diagram showing the schematic constitution of one example of a profile emphasizing circuit of the embodiment of the present invention;

FIG. 3 is a graph in which Table 1 is formed into a graph;

FIG. 4 is a view showing a timing chart of profile emphasizing processing of the embodiment of the present invention;

FIG. 5 is a block diagram showing one example of the circuit constitution for executing the profile emphasizing processing based on the timing chart shown in FIG. 4;

FIG. 6 is a block diagram showing the schematic constitution of another example of a profile emphasizing circuit of the embodiment of the present invention;

FIG. 7 is a graph in which Table 2 is formed into a graph;

FIG. 8 is a graph in which Table 3 is formed into a graph;

FIG. 9 is a schematic view for explaining a common inversion driving method;

FIG. 10 is a view showing the conventional circuit constitution for acquiring the reduction of power consumption by making use of a charge which is charged to a parasitic capacitance (Cpra) which is formed between a video line (S) and a counter electrode (ITO2) in a next inversion cycle in the common inversion driving method;

FIG. 11 is a view for explaining an operation of the circuit shown in FIG. 10;

FIG. 12 is a cross-sectional view showing the cross-sectional structure of an n-type MOS transistor which constitutes a switching element (SB) shown in FIG. 10;

FIG. 13 is a view showing the circuit constitution of the embodiment of the present invention for acquiring the reduction of power consumption by making use of a charge which is charged to a parasitic capacitance (Cpra) which is formed between a video line (S) and a counter electrode (ITO2) in a next inversion cycle in the common inversion driving method;

FIG. 14 is a cross-sectional view showing the cross-sectional structure of a p-type MOS transistor which constitutes a circuit C shown in FIG. 13;

FIG. 15 is a view showing a specific example of the p-type MOS transistor which constitutes a circuit C shown in FIG. 13;

FIG. 16 is a view showing a specific example of the p-type MOS transistor which constitutes a circuit C shown in FIG. 13;

FIG. 17 is a view showing a specific example of the p-type MOS transistor which constitutes a circuit C shown in FIG. 13;

FIG. 18 is a view showing a specific example of the p-type MOS transistor which constitutes a circuit C shown in FIG. 13;

FIG. 19 is a schematic view for explaining a charge redistributing operation when the constitution shown in FIG. 15 is adopted as a circuit C shown in FIG. 13;

FIG. 20 is a view showing the circuit constitution of another embodiment of the present invention for acquiring the reduction of power consumption by making use of a charge which is charged to a parasitic capacitance (Cpra) which is formed between a video line (S) and a counter electrode (ITO2) in a next inversion cycle in the common inversion driving method;

FIG. 21 is a schematic view for explaining an operation of the circuit constitution shown in FIG. 20;

FIG. 22 is a view showing one example of a register which sets time of periods (1′, 3′) and (1, 3) shown in FIG. 19, FIG. 21;

FIG. 23 is a view showing a state in which a portion of a part of a screen is displayed without using a full screen of a liquid crystal display panel (PNL); and

FIG. 24 is a view showing one example of a register which sets the number of lines of inversion cycles of the common inversion drive method.

### DETAILED DESCRIPTION OF THE INVENTION

Hereinafter, embodiments of the present invention are explained in detail in conjunction with drawings.

Here, in all drawings for explaining the embodiments, parts having identical functions are given same symbols and their repeated explanation is omitted.

### Embodiment

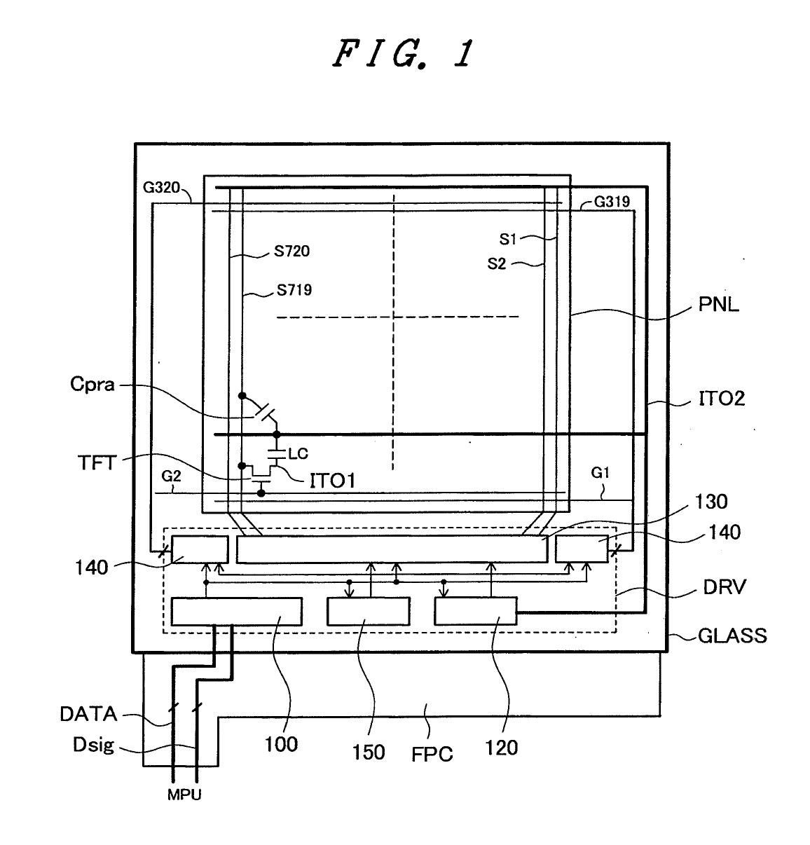

FIG. 1 is a block diagram showing the schematic constitution of a liquid crystal display module of an embodiment of the present invention.

On the liquid crystal display module (PNL), a plurality of scanning lines (or gate lines) (G1 to G320) and a plurality of video lines (or drain lines) (S1 to S720) are respectively arranged in parallel to each other.

Pixel portions are formed corresponding to portions where the scanning lines (G) and the video lines (S) intersect each other. A plurality of pixel portions are arranged in a matrix array, wherein each pixel portion includes a pixel electrode (ITO1) and a thin film transistor (TFT). In FIG. 1, the number of sub pixels of the liquid crystal display panel (PNL) is 240×320×3.

A counter electrode (also referred to as common electrode) (ITO2) is provided in a state that a counter electrode (ITO2) faces the respective pixel electrodes (ITO1) in an opposed manner with liquid crystal sandwiched therebetween. Accordingly, a liquid crystal capacitance (LC) is formed between each pixel electrode (ITO1) and the counter electrode (ITO2).

A liquid crystal display panel (PNL) is constituted such that a glass substrate (GLASS) on which the pixel electrodes (ITO1), the thin film transistors (TFT) and the like are formed and a glass substrate on which color filters and the like are formed (not shown in the drawings) are overlapped each other with a predetermined gap therebetween, both substrates are laminated to each other using a sealing material which is formed in a frame shape in the vicinity of a peripheral portion between both substrates, liquid crystal is filled and sealed into the inside of the sealing material between both substrates from a liquid crystal filling port formed in a portion of the sealing material and, further, polarizers are laminated to outer sides of both substrates.

Here, the present invention is irrelevant to the inner structure of the liquid crystal display panel and hence, the detailed explanation of the inner structure of the liquid crystal display panel is omitted. Further, the present invention is applicable to the liquid crystal display panel having any structure.

In this embodiment, on the glass substrate (GLASS), a drive circuit (DRV) is mounted. The drive circuit (DRV) includes a controller circuit 100, a source driver 130 which drives the video lines (S) of the liquid crystal display panel (PNL), a gate driver 140 which drives the scanning lines (G) of the liquid crystal display panel (PNL), a liquid crystal driving power source generating circuit 120 which generates a power source voltage necessary for displaying an image on the liquid crystal display panel (PNL) (for example, the common voltage (Vcom) which is supplied to the counter electrode (ITO2) of the liquid crystal display panel (PNL)), and a SRAM (Static Random Access Memory) 150. Further, in FIG. 1, symbol FPC indicates a flexible printed circuit board, symbol Cpra indicates a parasitic capacitance between the video line (S) and the counter electrode (ITO2).

Here, in FIG. 1, a case in which the drive circuit (DRV) is constituted of one semiconductor chip is illustrated. However, the drive circuit (DRV) may be directly formed on the glass substrate (GLASS) using, for example, a thin film transistor which uses low-temperature poly-silicon as a material of a semiconductor layer.

In the same manner, a circuit which constitutes a portion of the drive circuit (DRV) is divided thus constituting the drive circuit (DRV) using a plurality of semiconductor chips or a circuit which constitutes a portion of the drive circuit (DRV) maybe, for example, directly formed on the glass substrate (GLASS) using a thin film transistor which uses low-temperature poly-silicon as a semiconductor layer thereof.

Further, the drive circuit (DRV) or a circuit which constitutes a portion of the drive circuit (DRV) may be formed on a flexible wiring board in place of mounting the drive circuit (DRV) or the like on the glass substrate (GLASS).

The controller circuit 100 outputs respective signals which control the whole liquid crystal display module based on display data (DATA) and display control signals (DSig) which are inputted from an apparatus-side micro controller unit (hereinafter referred to as MCU) to the respective parts.

The thin film transistor (TFT) of each pixel portion allows a gate thereof to be connected with the scanning line (G) and the drain thereof to be connected to the video line (S). When a gate selection signal from the gate driver 140 is outputted to the scanning line (G), the thin film transistor (TFT) is turned on. When a video voltage is applied to the video line (S) from the source driver 130 in a state that the thin film transistor (TFT) assumes an ON state, the video voltage is applied to the pixel electrode (ITO1) through the thin film transistor (TFT), and a vide voltage is written in the liquid crystal capacitance (LC). Accordingly, an image is displayed on the liquid crystal display panel (PNL).

The display data (DATA) from the MCU is inputted to the controller circuit 100 and, thereafter, is stored in a desired address of the SRAM 150.

The data stored in the SRAM 150 is read out to the source driver 130 for every one display line at a fixed cycle, while the source driver 130 selects a gray scale voltage value corresponding to the read-out display data and supplies the gray scale voltage to the video lines (S1 to S720).

In this embodiment, in the inside of the controller circuit 100, a profile emphasizing circuit which emphasizes an edge portion of the image displayed on the liquid crystal display panel (PNL) is provided.

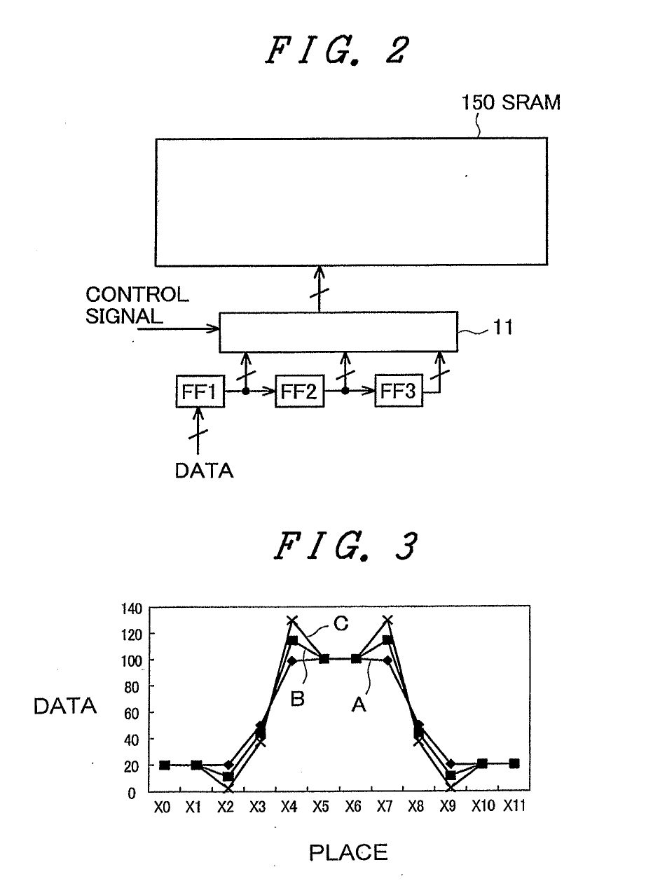

FIG. 2 is a block diagram showing the schematic constitution of one example of the profile emphasizing circuit of this embodiment. Here, in FIG. 2, symbols FF1, FF2, FF3 indicate latch circuits which latch display data (DATA).

In the profile emphasizing circuit shown in FIG. 2, a sub pixel which is latched by the latch circuit (FF1) and succeeds a target sub pixel by one pixel, the target sub pixel which is delayed by the latch circuit (FF1) and is latched by the latch circuit (FF2) and a sub pixel which is delayed by two latch circuits (or a flip-flop-circuits; FF1, FF2), is latched by the latch circuit (FF3) and precedes the target sub pixel by one sub pixel are inputted to the arithmetic circuit 11. In the arithmetic circuit 11, the weighting is applied to the display data of these three continuous sub pixels thus generating the profile-emphasized display data.

Here, assuming a display data value of the target sub pixel (Xn) as f (Xn), a display data value of the sub pixel (X(n−1)) which precedes the target sub pixel by one sub pixel as f(X(n−1)), a display data of the sub pixel (X(n+1)) which succeeds the target sub pixel by one sub pixel as f (X(n+1)), and a profile emphasized display data value of the target sub pixel as F (Xn), the arithmetic circuit 11 executes an operation described in the following (1) formula.

[Formula 1]

F(Xn)=A×f(X(n−1))+B×f(Xn)+C×f(X(n+1)) (1)

Here, A, B, C indicate filter coefficients.

For example, when original data exhibit values shown in Table 1 and A, B, C are respectively set as A=−0.3, B=1.6, C=−0.3, the profile emphasized display data values of the target sub pixels (X) and (X8) can be obtained by a following formula (2).

$$\begin{matrix}[ Formula 2 ] & \\ \begin{matrix}F ( X 3 ) = A \times f ( X 2 ) + B \times f ( X 3 ) + C \times f ( X 4 ) \\ = - 0.3 \times 20 + 1.6 \times 50 - 0.3 \times 100 \\ = 44 \\ F ( X 8 ) = - 0.3 \times 100 + 1.6 \times 50 - 0.3 \times 20 \\ = 44\end{matrix} & ( 2 )\end{matrix}$$

When the original data exhibit the values shown in Table 1 and filter coefficients are set such that A=−0.3, B=1.6, C=−0.3, the profile emphasized display data values are indicated as post-conversion data (1) in Table 1.

Further, when the original data exhibit the values shown in Table 1 and filter coefficients are set such that A=−0.6, B=2.2, C=−0.6, the profile emphasized display data values are indicated as post-conversion data (2) in Table 1.

FIG. 3 is a graph which is obtained by forming Table 1 into a graph.

In the graph shown in FIG. 3, (a) indicates the original data shown in Table 1, (b) indicates the post-conversion data (1) shown in Table 1 and (c) indicates the post-conversion data (2) shown in Table 1.

TABLE 1

| Place | X0 | X1 | X2 | X3 | X4 | X5 | X6 | X7 | X8 | X9 | X10 | X11 |
|---|---|---|---|---|---|---|---|---|---|---|---|---|
| Original Data | 20 | 20 | 20 | 50 | 100 | 100 | 100 | 100 | 50 | 20 | 20 | 20 |
| Post-Conversion | | 20 | 11 | 44 | 115 | 100 | 100 | 115 | 44 | 11 | 20 | |
| Data (1) | | | | | | | | | | | | |
| Post-Conversion | | 20 | 2 | 38 | 130 | 100 | 100 | 130 | 44 | 2 | 20 | |
| Data (2) | | | | | | | | | | | | |

In this embodiment, the sequence of profile emphasizing processing (the sequence which writes the display date in the SRAM 150 after emphasizing the profile of the display data by the profile emphasizing circuit) is performed by the 0 cycle processing. That is, with one pulse of write strobe signal (WR*) for writing the above-mentioned profile emphasizing processing is executed.

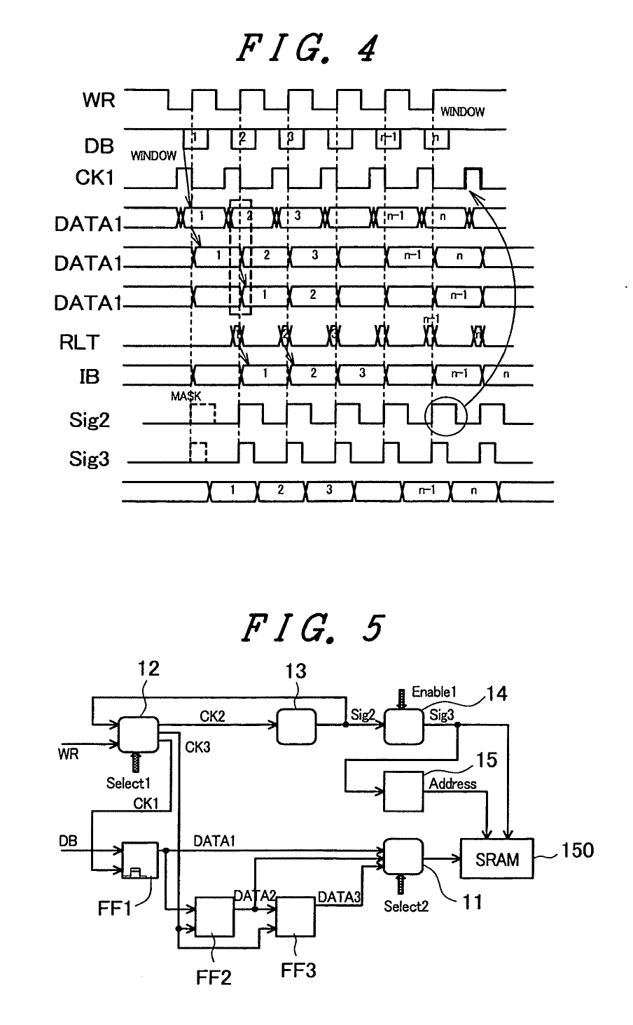

FIG. 4 is a view showing a timing chart of profile emphasizing processing of this embodiment.

The display data(DB) of a data bus is fetched into an inner bus in response to a latch pulse (CK1) generated based on the write strobe signal (WR*). Further, an access pulse which allows an access to the SRAM 150 and an address counter updating pulse (Sig3) for updating an address counter are also generated based on the write strobe signal (WR*).

As mentioned previously, in the profile emphasizing processing, it is necessary to perform the arithmetic operation on display data of the target pixel and both neighboring pixels and hence, it is necessary to temporarily hold the display data (DB).

Accordingly, first of all, the display data is, in the same manner as the usual writing, latched by the latch circuit (FF1 shown in FIG. 2) in response to the larch pulse (CK1) generated based on the write strobe signal (WR*) (DATA 1).

Further, an output of the latch circuit (FF1 shown in FIG. 2) is fetched in the latch circuit (FF2 shown in FIG. 2) at a falling edge of the latch pulse (CK1) (DATA2), and an output of the latch circuit (FF2 shown in FIG. 2) is fetched in the latch circuit (FF3 shown in FIG. 2) at the falling edge of the same latch pulse (DATA3). Accordingly, it is possible to hold the display data of the target pixel and both neighboring pixels.

Here, during a period surrounded by a broken line in FIG. 4, the display data of the target pixel and both neighboring pixels are provided and the profile emphasizing arithmetic operation is performed using these display data.

By fetching a result (RLT) of the profile emphasizing arithmetic operation into the inner bus (IB) at the above-mentioned falling edge of the latch pulse, a series of arithmetic processing is completed.

Here, when a motion picture display is performed only on a portion of a screen of the liquid crystal display panel (PNL), for example, in the inside of the window, it is needless to say that the above-mentioned profile emphasizing processing is applied to the display data on only the inside of the window. A window address indicates the display data on the inside of the window.

Here, it is necessary not to perform the arithmetic operation with respect to the pixels at both ends of the window address. For this purpose, the pixels at both ends are determined based on the value of the address counter and a flag which indicates a period in which the arithmetic operation is not performed is generated.

In the method shown in FIG. 4, the writing timing to the SRAM 150 is delayed by one pixel. Accordingly, it is necessary to also delay the SRAM access pulse (Sig2) and the address counter updating pulse (Sig3) by one pixel.

These may be masked at a starting point of the window address. However, in writing the arithmetic operation data of a finish point of the window address in the inner bus, the write strobe signal (WR*) is not inputted and hence, it is impossible to write the arithmetic operation result of the final pixel into the inner bus or to generate the pulse which allows the access to the SRAM 150. Accordingly, in this embodiment, in an interface part of the control circuit 100, a pulse for processing the final display data is generated.

As shown in FIG. 4, in response to a pulse which is surrounded by a circle in FIG. 4 out of the SRAM access pulses (Sig2) which are generated by write strobe signal (WR*) when the display data of the final pixel for one frame is transferred, the latch pulse (indicated by bold solid line in FIG. 4) is generated. Here, when the display data is transferred twice, two latch pulses are generated, while when the display data is transferred three times, three latch pulses are generated.

It is possible to write down the arithmetic operation result of the final pixel into the SRAM 150 based on pulses which are generated in this manner.

FIG. 5 is a block diagram showing one example of the circuit constitution for executing the profile emphasizing processing based on the timing chart shown in FIG. 4.

In FIG. 5, the latch circuits FF1, FF2, FF3 are latch circuits which latch the display data of the target pixel and both neighboring pixels, wherein numeral 11 indicates an arithmetic circuit which performs the above-mentioned profile emphasizing arithmetic operation.

Further, numeral 12 indicates a pulse generating circuit (1), numeral 13 indicates the pulse generating circuit (2), numeral 14 indicates a pulse generating circuit (3), and numeral 15 indicates an address counter.

The pulse generating circuit (1) 12 generates a latch pulse (CK1), a pulse (CK2), and a pulse (CK3) whose rising edge agrees with a falling edge of the latch pulse (CK1) based on the write strobe signal (WR*) and the SRAM access pulse (Sig2) outputted from the pulse generating circuit (2) 13.

Further, a control signal (Select 1) is inputted to the pulse generating circuit (1) 12, and based on the control signal (Select 1) the write strobe signal (WR*) is inputted to the pulse generating circuit (1) 12 until the display data of the final pixel for one frame is transferred, and the SRAM access pulse (Sig2) which is outputted from the pulse generating circuit (2) 13 is inputted to the pulse generating circuit (1) 12 after the display data of the final pixel for one frame is transferred.

The pulse generating circuit (1) 12 generates the above-mentioned respective pulses in synchronism with the falling of the pulse and hence, the pulse generating circuit (1) 12 can, as shown in FIG. 4, generate the latch pulse (indicated by bold solid line in FIG. 4) based on the pulse surrounded by the circle in FIG. 4 out of the SRAM access pulses (Sig2) which are generated based on the write strobe signal (WR*) when the display data of the final pixel for one frame is transferred.

The pulse generating circuit (2) 13 generates the SRAM access pulse (Sig2) in response to the pulse (CK2) outputted from the pulse generating circuit (1) 12.

The pulse generating circuit (3) 14 generates the address counter updating pulse (Sig3) in response to the SRAM access pulse (Sig2) outputted from the pulse generating circuit (2) 13.

A control signal (enable1) is inputted to the pulse generating circuit (3) 14, and the pulse generating circuit (3) 14 masks the SRAM access pulse (Sig2) outputted from the pulse generating circuit (2) 13 at a starting point of the window address.

As has been explained above, according to this embodiment, the display data (DATA) is transferred for every pixel unit and hence, the arithmetic operation with respect to the data writing direction is realized by temporarily holding the data on the target sub pixel and the preceding data are temporarily held in the buffer, and the arithmetic operation is performed at a stage that the next data is transferred so as to write the display data to the SRAM 150.

In this case, additional circuits are constituted of latch circuits (FF2, FF3) for two pixels (3×6 bit×2), the arithmetic circuit 11 and a timing generating circuit relevant to these circuits. Since the processing can be performed for everyone pixel using only the control circuit 100, the change from the conventional system can be minimized whereby a circuit scale can be minimized.

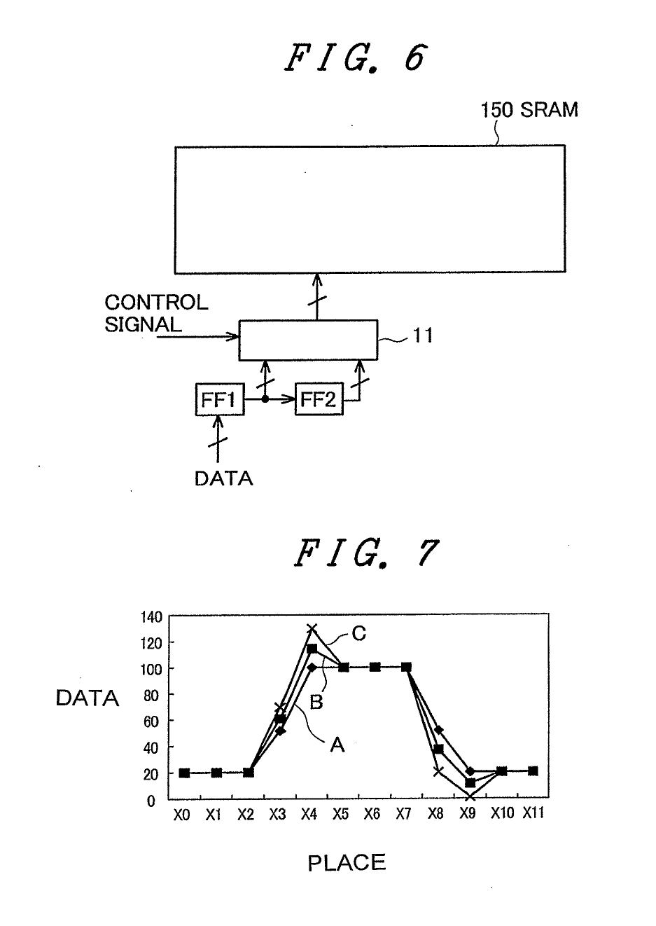

FIG. 6 is a block diagram showing the schematic constitution of another example of the profile emphasizing circuit of this embodiment. In the profile emphasizing circuit shown in FIG. 6, the arithmetic circuit 11 applies the weighting to the display data of the target sub pixel and the display data of the sub pixel which precedes the target sub pixel by one sub pixel thus generating the profile emphasized display data.

Here, assuming a display data value of the target sub pixel (Xn) as f (Xn), a display data value of the sub pixel (X(n−1)) which precedes the target sub pixel by one sub pixel as f (X (n−1)), and a profile emphasized display data value of the target sub pixel as F (Xn), the arithmetic circuit 11 executes an operation described in the following (3) formula.

[Formula 3]

F(Xn)=A′×f(X(n−1)+B′×f(Xn) (3)

Here, A′, B′ indicate filter coefficients.

For example, when original data exhibit values shown in Table 2 and A′, B′ are respectively set as A′=−0.3, B′=1.3, the profile emphasized display data values of the target sub pixels (X3) and (X8) can be obtained by a following formula (4).

$$[ Formula 4 ]$$

$$\begin{matrix}F ( X 3 ) = {A}^{′} \times f ( X 2 ) + {B}^{′} \times f ( X 3 ) \\ = - 0.3 \times 20 + 1.3 \times 50 \\ = 59 \\ F ( X 8 ) = - 0.3 \times 100 + 1.3 \times 50 \\ = 35\end{matrix} \qquad ( 4 )$$

When the original data exhibit the values shown in Table 1 and filter coefficients are set such that A′=−0.3, B′=1.3, the profile emphasized display data values are indicated as post-conversion data (1) in Table 2.

Further, when the original data exhibit the values shown in Table 2 and filter coefficients are set such that A′=−0.6, B′=1.6, the profile emphasized display data values are indicated as post-conversion data (2) in Table 2.

FIG. 7 is a graph which is obtained by forming Table 2 into a graph.

In the graph shown in FIG. 7, (a) indicates the original data shown in Table 2, (b) indicates the post-conversion data (1) shown in Table 2 and (c) indicates the post-conversion data (2) shown in Table 2.

TABLE 2

| Place | X0 | X1 | X2 | X3 | X4 | X5 | X6 | X7 | X8 | X9 | X10 | X11 |
|---|---|---|---|---|---|---|---|---|---|---|---|---|
| Original Data | 20 | 20 | 20 | 50 | 100 | 100 | 100 | 100 | 50 | 20 | 20 | 20 |
| Post-Conversion | | 20 | 20 | 59 | 115 | 100 | 100 | 100 | 35 | 11 | 20 | |
| Data (1) | | | | | | | | | | | | |
| Post-Conversion | | 20 | 20 | 68 | 130 | 100 | 100 | 100 | 20 | 2 | 20 | |
| Data (2) | | | | | | | | | | | | |

In the profile emphasizing circuit shown in FIG. 6, the arithmetic circuit 11 may apply the weighting to the display data on the target sub pixel and the display data on the sub pixel which succeeds the target sub pixel by one sub pixel so as to generate the profile-emphasized display data. Here, assuming a display data value of the target sub pixel (Xn) as f (Xn), a display data value of the sub pixel (X (n+1)) which succeeds the target sub pixel by one sub pixel as f (X (n+1)), and a profile emphasized display data value of the target sub pixel as F (Xn), the arithmetic circuit 11 executes an operation described in the following (5) formula.

[Formula 5]

F(Xn)=B′×f(Xn)+C′×f(X(n+1) (5)

Here, B′, C′ indicate filter coefficients.

For example, when original data exhibit values shown in Table 3 and B′, C′ are respectively set as B′=1.3, C′=−0.3, the profile emphasized display data values of the target sub pixels (X3) and (X8) can be obtained by a following formula (6).

$$[ Formula 6 ]$$

$$\begin{matrix}F ( X 3 ) = {B}^{′} \times f ( X 3 ) + {C}^{′} \times f ( X 4 ) \\ = 1.3 \times 50 - 0.3 \times 100 \\ = 35 \\ F ( X 8 ) = 1.3 \times 50 - 0.3 \times 20 \\ = 59\end{matrix} \qquad ( 6 )$$

When the original data exhibit the values shown in Table 3 and filter coefficients are set such that B′=1.3, C′=−0.3, the profile emphasized display data values are indicated as post-conversion data (1) in Table 3.

Further, when the original data exhibit the values shown in Table 3 and filter coefficients are set such that B′=1.6, C′=−0.6, the profile emphasized display data values are indicated as post-conversion data (2) in Table 3.

FIG. 8 is a graph which is obtained by forming Table 3 into a graph.

In the graph shown in FIG. 8, (a) indicates the original data shown in Table 3, (b) indicates the post-conversion data (1) shown in Table 3 and (c) indicates the post-conversion data (2) shown in Table 3.

TABLE 3

| Place | X0 | X1 | X2 | X3 | X4 | X5 | X6 | X7 | X8 | X9 | X10 | X11 |
|---|---|---|---|---|---|---|---|---|---|---|---|---|
| Original Data | 20 | 20 | 20 | 50 | 100 | 100 | 100 | 100 | 50 | 20 | 20 | 20 |
| Post-Conversion | | 20 | 11 | 35 | 100 | 100 | 100 | 115 | 59 | 20 | 20 | |
| Data (1) | | | | | | | | | | | | |
| Post-Conversion | | 20 | 2 | 20 | 100 | 100 | 100 | 130 | 68 | 20 | 20 | |
| Data (2) | | | | | | | | | | | | |

In general, when a DC voltage is applied to the liquid crystal, the liquid crystal is degraded and hence, it is necessary to use the voltage after converting the DC voltage into an AC voltage.

In this embodiment, as an AC driving method, a common inversion driving method is used.

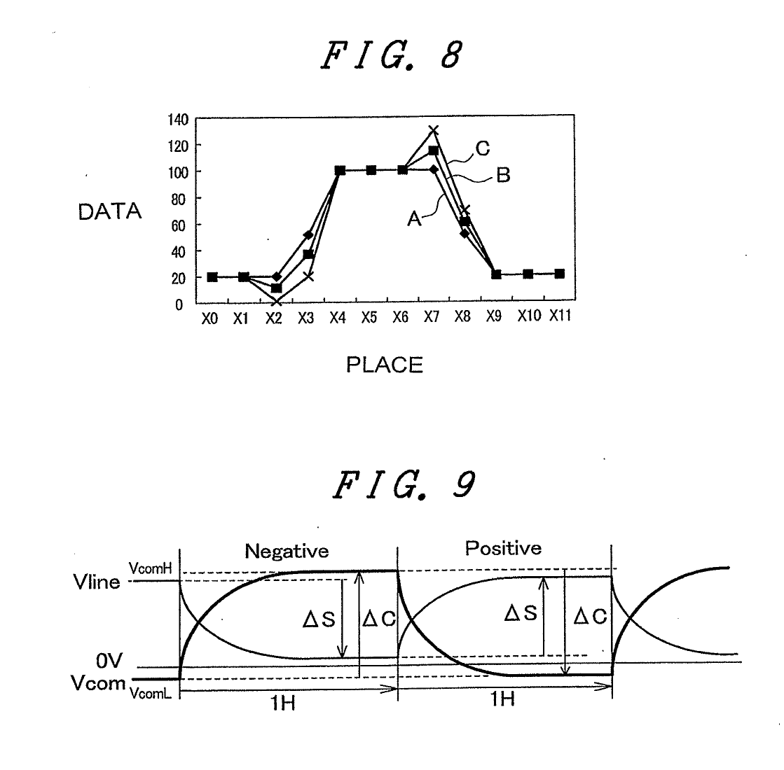

FIG. 9 is a schematic view for explaining a common inversion driving method and also is a view showing the relationship between a video voltage (Vline) which is applied to the video lines (S) and the common voltage (Vcom) which is applied to the counter electrode (ITO2).

Here, in FIG. 9, the inversion cycle of the common inversion driving method is illustrated in case of 1 horizontal period (1H). However, in this inversion cycle may be, for example, 2 horizontal periods, 3 horizontal periods or 1 frame period. The inversion cycle of the common inversion driving method is selected in conformity with an image quality.

As shown in FIG. 9, voltages of the video voltage (Vline) and the common voltage (Vcom) are changed over to either video voltage (Vline)>common voltage (Vcom) or video voltage (Vline)<common voltage (Vcom) corresponding to the inversion cycle of the common inversion driving method.

As a method which can reduce the power consumption in the common inversion driving method by making use of such driving, there exist a method which makes use of a charge which is charged in a parasitic capacitance (CPRA) which is formed between the video line (S) and the counter electrode (ITO2) in the succeeding 1 horizontal period.

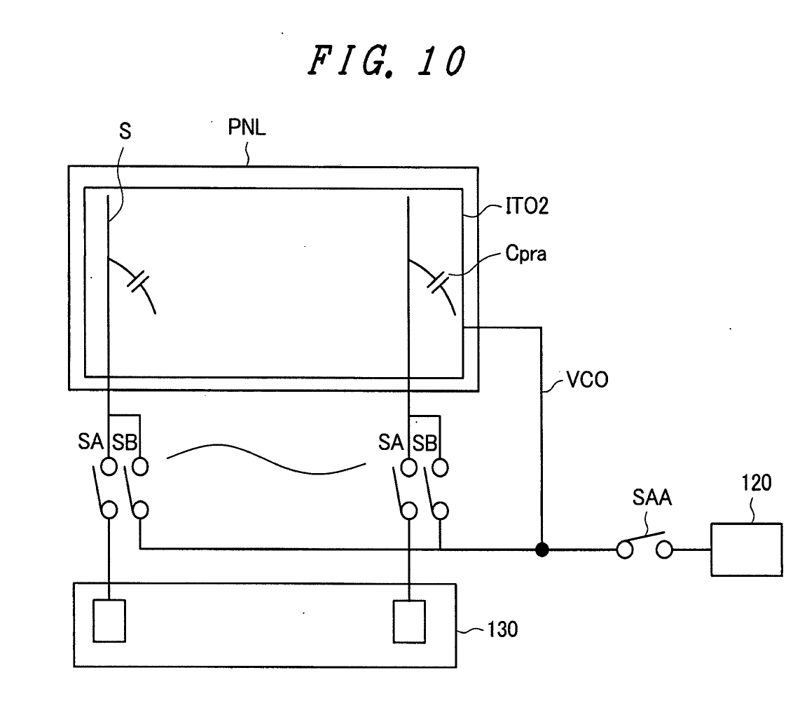

FIG. 10 is a view showing the conventional circuit constitution for acquiring the reduction of power consumption by making use of a charge which is charged to a parasitic capacitance (Cpra) which is formed between the video line (S) and the counter electrode (ITO2) in the succeeding inversion cycle.

As shown in FIG. 10, in the inside of a source driver 130, a switching element (SA) is provided between the video line (S) and an output circuit of the source driver 130 and, at the same time, a switching element (SB) is provided between the video line (S) and the counter electrode line (COM).

Further, the counter electrode line (COM) is connected to the counter electrode (ITO2), while the counter electrode line (COM) is connected to a power source circuit 120 via a switching element (SAA).

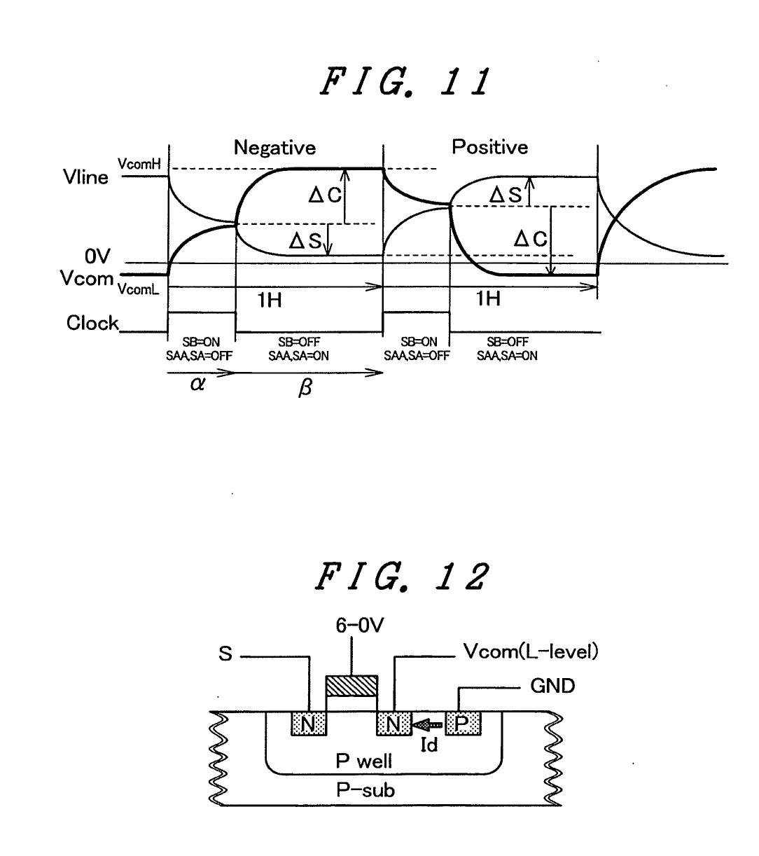

FIG. 11 is a view for explaining an operation of the circuit shown in FIG. 10.

In the front half portion (period α) of one 1 horizontal period, the switching element (SA) and the switching element (SAA) are turned off and the switching element (SB) is turned on thus short-circuiting the video line (S) and the counter electrode line (COM) whereby the charge is moved between the video line (S) and the counter electrode (ITO2) during this period. Only the movement of the charge occurs during this period and hence, there is no consumption of electricity. Thereafter (period β), the switching element (SA) and the switching element (SAA) are turned on and the switching element (SB) is turned off and hence, the usual driving is performed. Due to such an operation, the consumption of electricity for driving the liquid crystal display panel (PNL) can be reduced by an amount of the movement of the charge during the period α. That is, it is possible to decrease ΔS and ΔC in FIG. 11.

However, the above-mentioned technique can not be adopted due to the following reason.

The above-mentioned switching element (SAA, SA, SB) is constituted of a transfer gate circuit in which a p-type MOS transistor and an n-type MOS transistor are connected to each other in parallel.

An output of the source driver 130 shown in FIG. 10 often assumes approximately 0 to 5V and hence, as the n-type MOS transistor of the switching element (SA, SAA, SB) shown in FIG. 10, an n-type MOS transistor which is prepared by a semiconductor process of a dielectric resistance of approximately 5 to 6V is used. In the usual semiconductor process, the fact that the size of the n-type MOS transistor is small and the driving ability of the n-type MOS transistor is relatively high so long as the dielectric strength is approximately 6V may be also one of the reasons that the n-type MOS transistor is used.

Further, to realize the low power consumption, a negative power source side may be set to a ground potential (GND). This is because that the electricity consumption for charging the liquid crystal load at the time of driving the video line (S) downwardly becomes 0. In view of the above, the power source of the source driver 130 is set to 6V-GND in general.

Here, it is needless to say that 6V is used only for an illustration purpose and the voltage is not limited to 6V and, the voltage can be suitably changed in conformity with a use condition. For example, the voltage can be set to 5.5V or the like.

The voltage may be generated by a booster circuit in the inside of the liquid crystal driving power source generating circuit 120 or may be supplied from the outside as a matter of cause.

FIG. 12 is a cross-sectional view showing the cross-sectional structure of an n-type MOS transistor which constitutes a switching element (SB) shown in FIG. 10.

As shown in FIG. 12, the n-type MOS transistor of the switching element (SB) shown in FIG. 10 has a drain (or a source) thereof connected to the video line (S) and the source (or the drain) thereof connected to the counter electrode line (COM). Then, to a gate of the n-type MOS transistor, as a substrate (or a p-type well) potential to which the voltage of 6-0V is applied, a ground potential (GND) is applied.

Here, to take the driving of the liquid crystal display panel (PNL) into consideration, a Low level (hereinafter referred to as L level) of the common voltage (Vcom) of the counter electrode (ITO2) usually assumes a negative voltage. This is because that due to a coupling capacitance between a gate of the thin film transistor (TFT; NMOS) which constitutes an active element and the liquid crystal, when the thin film transistor (TFT) is turned off, a jumping voltage is generated in the liquid crystal.

When the L level of the common voltage (Vcom) of the counter electrode (ITO1) assumes a negative voltage, as shown in FIG. 12, a PN junction in the forward direction is generated between the p-type substrate and the n-type source (or drain) and hence, an extra current (Id) flows.

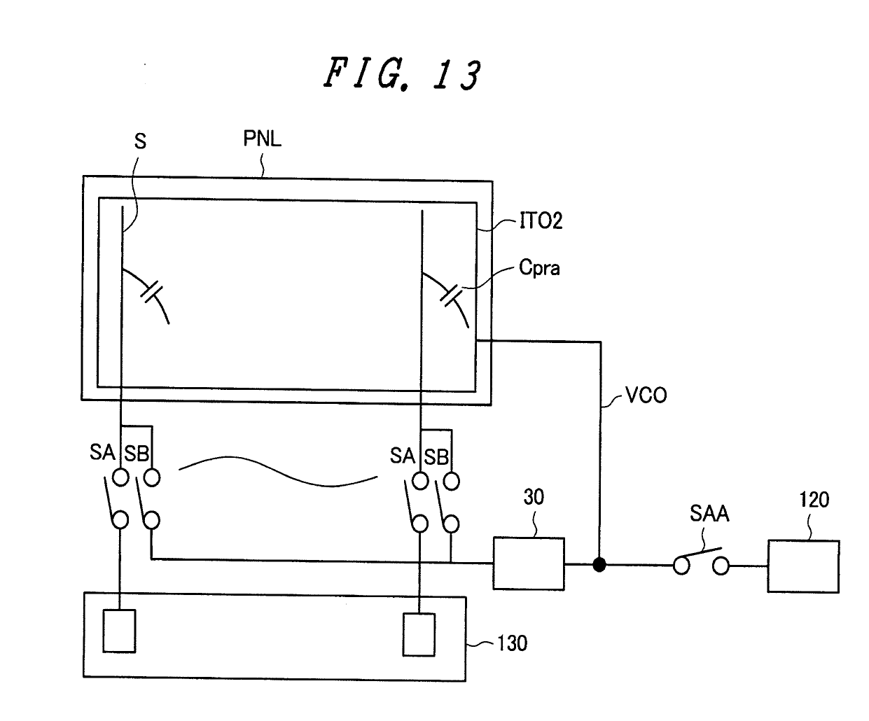

To overcome the above-mentioned drawback, in this embodiment, as shown in FIG. 13, to a charge redistribution path of the counter electrode line (COM), a circuit C (30) which is constituted of a p-type MOS transistor is added.

Here, FIG. 13 is a view showing, in the common inversion driving method, the circuit constitution of this embodiment for acquiring the reduction of power consumption by making use of a charge which is charged to a parasitic capacitance (Cpra) which is formed between the video line (S) and the counter electrode (ITO2) in the succeeding inversion cycle in the common inversion driving method.

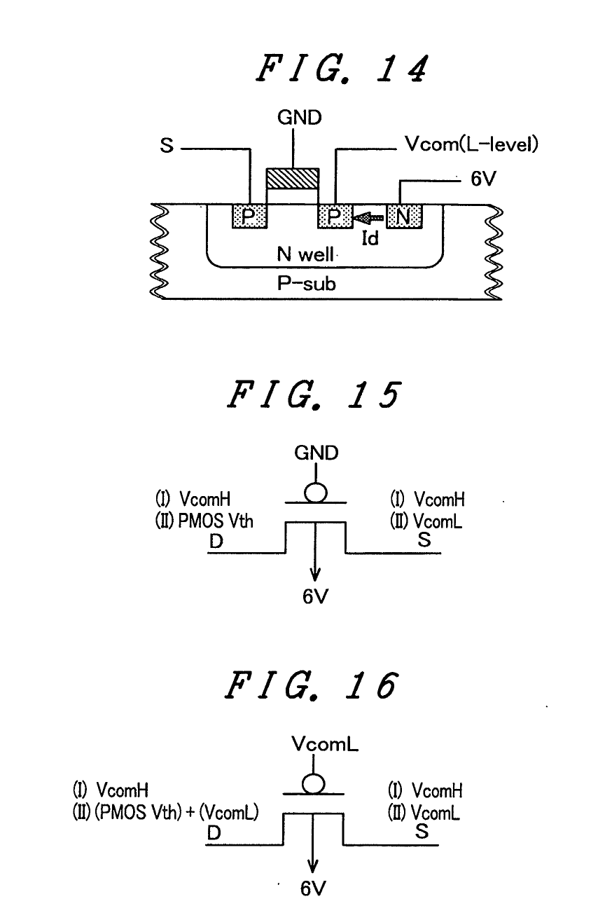

FIG. 14 is a cross-sectional view showing the cross-sectional structure of p-type MOS transistor which constitutes the circuit C (30) shown in FIG. 13.

As shown in FIG. 14, the p-type MOS transistor which constitutes the circuit C (30) shown in FIG. 13 has a drain (or a source) side (D side in FIG. 15 to FIG. 18) thereof connected to the video line (S) and the source (or the drain) side (S side in FIG. 15 to FIG. 18) thereof connected to the counter electrode line (COM).

Then, as the substrate (or n-type well) potential, a voltage which is equal to or higher than a High level (hereinafter referred to as H level) voltage (VcomH) of the common voltage (Vcom) is applied, while the voltage of a voltage level which does not generate a negative voltage on the drain (or source) side is applied to the gate.

FIG. 15 to FIG. 18 are views showing specific examples of p-type MOS transistor which constitutes the circuit C (30) shown in FIG. 13.

In an example shown in FIG. 15, a voltage applied to the gate is set to GND (0V), and 6V is applied as the substrate potential. Here, 6V which is applied as the substrate potential exists as a source driver driving power source. It is needless to say that, however, the substrate potential may be a voltage higher than the H-level voltage (VcomH) of the common voltage (Vcom).

When the common voltage (Vcom) is the H-level voltage (VcomH) (when the common voltage (Vcom) assumes a state (I) shown in FIG. 15), a voltage higher than a voltage level which is applied to the gate is generated at the counter electrode (ITO2) and hence, a voltage having the same voltage level as the H-level voltage (VcomH) of the common voltage (Vcom) is outputted to the drain (or source) side.

When the common voltage (Vcom) is the L-level voltage (VcomL) (when the common voltage (Vcom) assumes a state (II) shown in FIG. 15), a voltage lower than a voltage level which is applied to the gate is generated at the counter electrode (ITO2) and hence, a voltage which is obtained by adding a threshold voltage (PMOS Vth) of the p-type MOS transistor which constitutes the circuit C (30) shown in FIG. 13 to 0V applied to the gate is outputted to the drain (or source) side.

Accordingly, a negative voltage is not applied to the drain (or source) side and hence, in the n-type MOS transistor of the switching element (SB), a PN junction in the forward direction is formed between the p-type substrate and the n-type source (or drain) whereby it is possible to prevent the flow of an extra current.

In an example shown in FIG. 16, a voltage applied to the gate is set to the L-level voltage (VcomL) of the common voltage (Vcom), and 6V is applied as the substrate potential. When the common voltage (Vcom) is the H-level voltage (VcomH) (when the common voltage (Vcom) assumes a state (I) shown in FIG. 16), a voltage higher than a voltage level which is applied to the gate is generated at the counter electrode (ITO2) and hence, a voltage having the same voltage level as the H-level voltage (VcomH) of the common voltage (Vcom) is outputted to the drain (or source) side.

When the common voltage (Vcom) is the L-level voltage (VcomL) (when the common voltage (Vcom) assumes a state (II) shown in FIG. 16), a voltage same as the voltage level which is applied to the gate is generated at the counter electrode (ITO2) and hence, a voltage which is obtained by adding a threshold voltage (PMOS Vth) of the p-type MOS transistor which constitutes the circuit C (30) shown in FIG. 13 to the L-level voltage (VcomL) of the common voltage (Vcom) applied to the gate is outputted to the drain (or source) side.

Here, to prevent a negative voltage from being applied to the drain (or source) side, it is necessary to satisfy a relationship ((PMOS Vth)+VcomL)≧0 and provided that such a relationship is satisfied, the operation can be effectively performed.

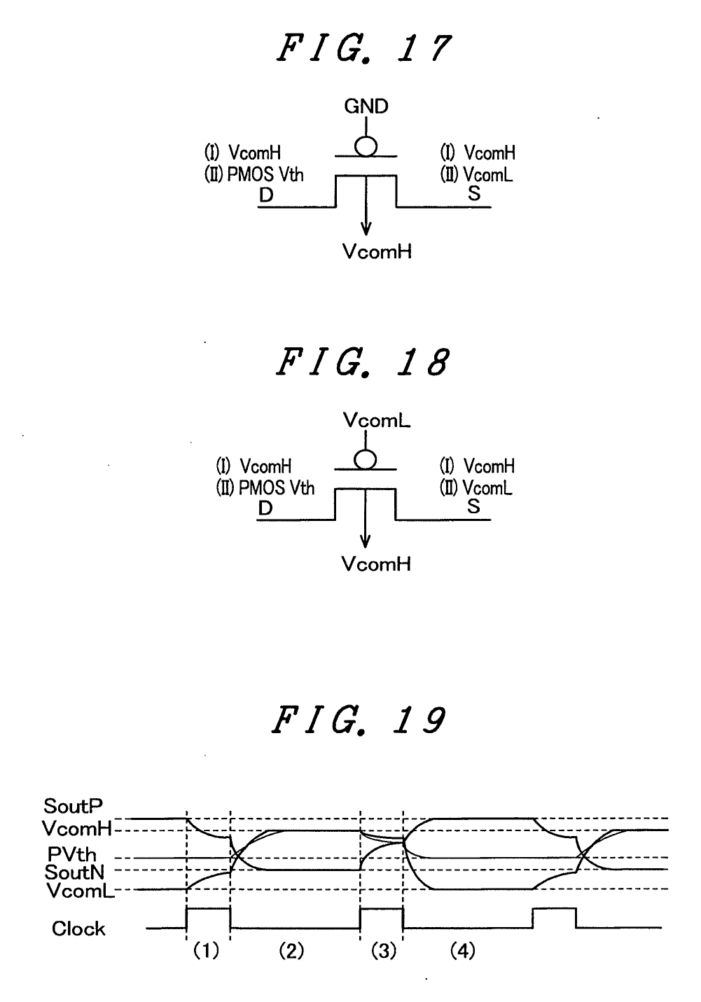

In an example shown in FIG. 17, a voltage applied to the gate is set to GND (0V), and H-level voltage (VcomH) of the common voltage (Vcom) is applied as the substrate potential.

When the common voltage (Vcom) is the H-level voltage (VcomH) (when the common voltage (Vcom) assumes a state (I) shown in FIG. 17), a voltage higher than a voltage level which is applied to the gate is generated at the counter electrode (ITO2) and hence, a voltage having the same voltage level as the H-level voltage (VcomH) of the common voltage (Vcom) is outputted to the drain (or source) side.

When the common voltage (Vcom) is the L-level voltage (VcomH) (when the common voltage (Vcom) assumes a state (II) shown in FIG. 17), a voltage lower than a voltage level which is applied to the gate is generated at the counter electrode (ITO2) and hence, a voltage which is obtained by adding a threshold voltage (MOS Vth) of the p-type MOS transistor which constitutes the circuit C (30) shown in FIG. 13 to 0V applied to the gate is outputted to the drain (or source) side. Accordingly, a negative voltage is not applied to the drain (or source) side.

In an example shown in FIG. 18, a voltage applied to the gate is set to the L-level voltage (VcomL) of the common voltage (Vcom), and the H-level voltage (VcomH) of the common voltage (Vcom) is applied as the substrate potential.

When the common voltage (Vcom) is the H-level voltage (VcomH) (when the common voltage (Vcom) assumes a state (I) shown in FIG. 18), a voltage higher than a voltage level which is applied to the gate is generated at the counter electrode (ITO2) and hence, a voltage having the same voltage level as the H-level voltage (VcomH) of the common voltage (Vcom) is outputted to the drain (or source) side.

When the common voltage (Vcom) is the L-level voltage (VcomL) (when the common voltage (Vcom) assumes a state (II) shown in FIG. 15), a voltage same as the voltage level which is applied to the gate is generated at the counter electrode (ITO2) and hence, a voltage which is obtained by adding a threshold voltage (PMOS Vth) of the p-type MOS transistor which constitutes the circuit C (30) shown in FIG. 13 to the L-level voltage (VcomL) of the common voltage (Vcom) applied to the gate is outputted to the drain (or source) side.

Here, to prevent a negative voltage from being applied to the drain (or source) side, it is necessary to satisfy a relationship ((MOS Vth)+VcomL)≧0 and provided that such a relationship is satisfied, the operation can be effectively performed.

In the examples shown in FIG. 15 to FIG. 18, when the common voltage (Vcom) assumes the L-level voltage (VcomL) (when the common voltage (Vcom) assumes the state (II) shown in each drawing), the voltage to which the threshold voltage of the p-type MOS transistor (PMOS Vth) is added is outputted and hence, when the threshold voltage (PMOS Vth) is high, the movement of charge between the common voltage (Vcom) and the video voltage (Vline) tends to be decreased.

Accordingly, by lowering the threshold voltage (PMOS Vth) to an extent that a negative potential is not outputted to the drain (or the source) side when the common voltage (Vcom) assumes the state (II) shown in each drawing, it is possible to further increase an effect of the movement of the charge between the common voltage (Vcom) and the video voltage (Vline).

To be more specific, the threshold voltage (PMOS Vth) which allows the establishment of a relationship PMOS Vth≈0V under use conditions (having a back bias) shown in FIG. 15 and FIG. 17 and the establishment of a relationship (PMOS Vth)+VcomL≈0V under use conditions (having a back bias) shown in FIG. 16 and FIG. 18 is preferably applied to the p-type MOS transistor of the circuit C (30) shown in FIG. 13.

This can be realized by adjusting the threshold voltage of the p-type MOS transistor of the circuit C (30).

Further, with respect to the use conditions shown in FIG. 15 to FIG. 18, the explanation has been made with respect to the case in which the relationship (PMOS Vth)≧0 is established with respect to FIG. 15 and FIG. 17 and the relationship ((PMOS Vth)+VcomL)≧0 is established with respect to FIG. 16 and FIG. 18. However, the above-mentioned constitution is provided for preventing the flow of the extra current (ID) which flows in the forward PN junction shown in FIG. 12. From this purpose, the presence of a trivial negative potential (usually approximately 0.1V to 0.2V) which does not exceed a VF of the PN junction is allowed with respect to the relationship (PMOS Vth)0 or the relationship ((PMOS Vth)+VcomL)÷0.

FIG. 19 is a schematic view for explaining a charge redistributing operation when the constitution shown in FIG. 15 is adopted as the circuit C (30) shown in FIG. 13. In FIG. 19, symbol SoutP is a H-level voltage of the video voltage (Vline) which is applied to the video lines (S), symbol SoutN is a L-level voltage of the video voltage (Vline) which is applied to the video lines (S), symbol VcomH is a H-level voltage of the common voltage (Vcom), symbol VcomL is a L-level voltage of the common voltage (Vcom), and symbol PVth indicates a threshold voltage of the p-type MOS transistor which constitutes the circuit C (30) shown in FIG. 13.

### Period (1): Charge Redistributing Operation Period

In this period, the switching element (SA) and the switching element (SAA) shown in FIG. 13 are turned off and the switching element (SB) shown in FIG. 13 is turned on thus short-circuiting the video line (S) and the counter electrode line (COM).

Although the video voltage (Vline) of the video line (S) and the common voltage (Vcom) of the common electrode (ITO2) approximate to each other, there may be a case in which a reaching point becomes close to a high voltage side due to the limitation of voltage attributed to the p-type MOS transistor which constitutes the circuit C (30).

Further, when the video voltage (Vline) of the video line (S) is lower than or close to the threshold voltage of the p-type MOS transistor which constitutes the circuit C (30), the charge redistribution effect is decreased. That is, the charge redistribution effect during this period is liable to become smaller compared to the charge redistribution effect during the period (3) described later.

### Period (2): Usual Operation

During this period, the switching element (SA) and the switching element (SAA) shown in FIG. 13 are turned off and the switching element (SB) shown in FIG. 13 is turned on thus short-circuiting the video line (S) and the counter electrode line (COM).

### Period (3): Charge Redistributing Operation Period

In this period, the switching element (SA) and the switching element (SAA) shown in FIG. 13 are turned off and the switching element (SB) shown in FIG. 13 is turned on thus short-circuiting the video line (S) and the counter electrode line (COM).

Although the video voltage (Vline) of the video line (S) and the common voltage (Vcom) of the common electrode (ITO2) approximate to each other, there may be a case in which a reaching point becomes close to a high voltage side due to the limitation of voltage attributed to the p-type MOS transistor which constitutes the circuit C (30).

When the H-level voltage (VcomH) of the common voltage (Vcom) is larger (usually larger) than the threshold voltage (PVth) of the p-type MOS transistor which constitutes the circuit C(30), the charge redistributing effect is considered sufficient.

### Period (4): Usual Operation

During this period, the switching element (SA) and the switching element (SAA) shown in FIG. 13 are turned on and the switching element (SB) shown in FIG. 13 is turned off.

Here, in the explanation made heretofore, the explanation has been made with respect to the case in which the circuit C(30) which is constituted of the p-type MOS transistor is added to the charge redistributing path of the counter electrode line (COM), in the circuit constitution shown in FIG. 10, it is also possible to obtain the substantially same advantageous effects by constituting the switching element (SB) using the p-type MOS transistor.

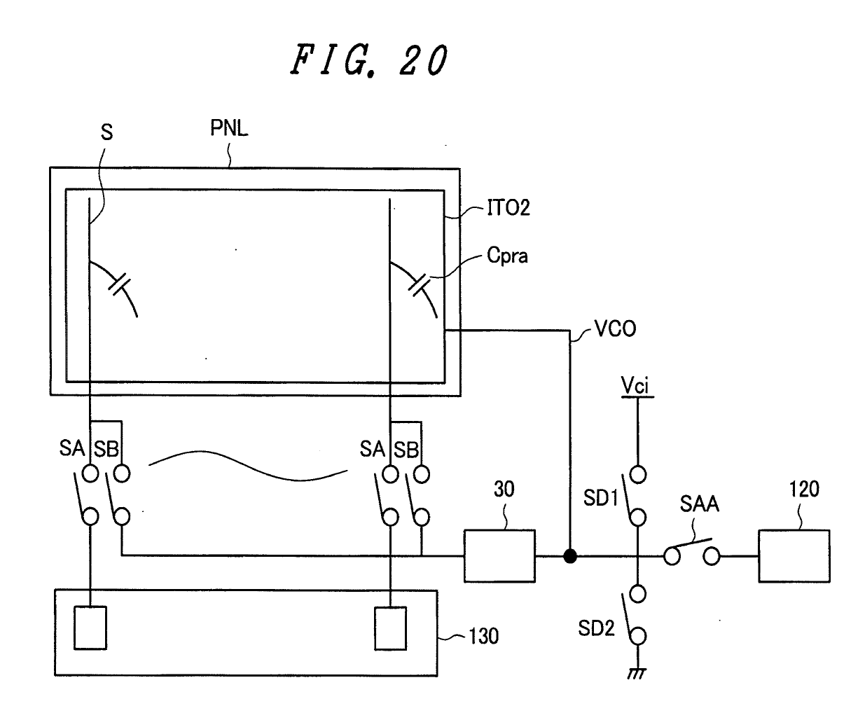

FIG. 20 is a view showing another circuit constitution of this embodiment for acquiring the reduction of power consumption by making use of a charge which is charged between the video line (S) and the counter electrode (ITO2) in the succeeding inversion cycle in the common inversion driving method.

The circuit constitution shown in FIG. 20 differs from the circuit constitution shown in FIG. 13 with respect to a point that a reference potential (Vci) is applied to a path between the switching element (SAA) and the circuit C(30) by way of a switching element (SD1) and a ground potential (GND) is applied to the path between the switching element (SAA) and the circuit C(30) by way of a switching element (SD2).

Here, among an H-level voltage (VcomH) and an L-level voltage (VcomL) of the common voltage (Vcom), the reference potential (Vci) and the ground potential (GND), a relationship described by a following formula (7) is established.

[Formula 7]

VcomH>Vci>GND>VcomL (7)

Although it has been known that the reduction of power consumption can be realized by changing a level with the use of gradually changing voltages having low boosting magnification, the circuit constitution shown in FIG. 20 is provided for realizing the reduction of power consumption by making use of the reference potential (Vci) and the ground potential (GND).

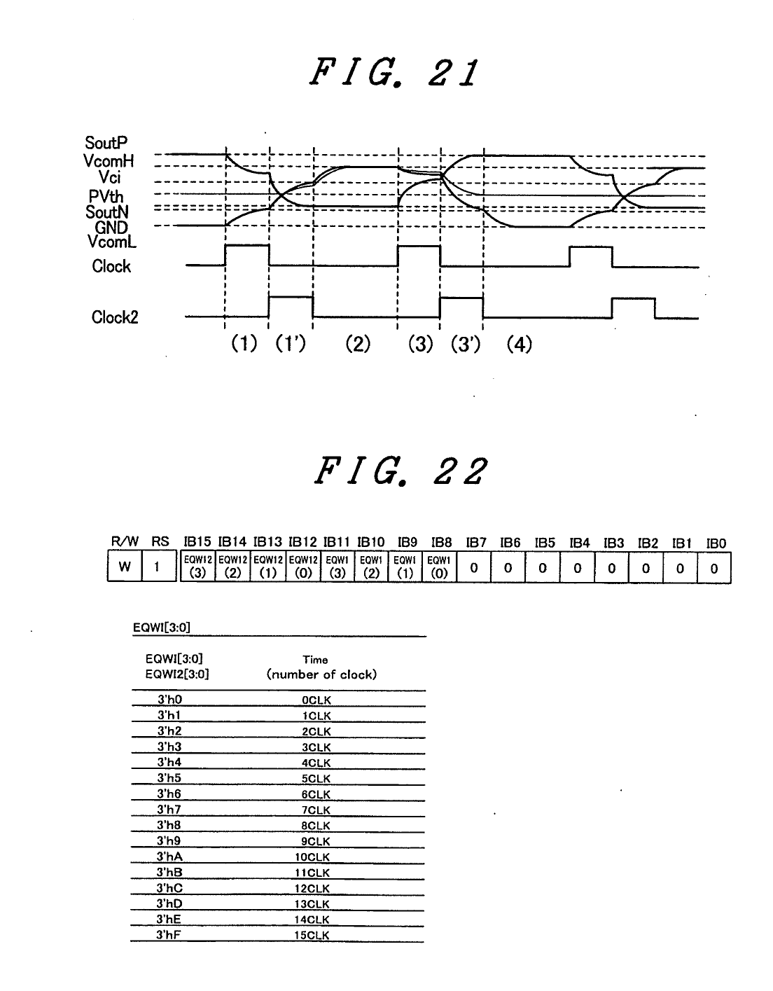

FIG. 21 is a schematic view for explaining an operation of the circuit constitution shown in FIG. 20. In the schematic view shown in FIG. 21, since periods (1) to (4) are equal to the periods (1) to (4) in the schematic view in FIG. 19 and hence, the repeated explanation of these periods is omitted.

### Period (1′)

In this period, in FIG. 20, the switching element (SA), the switching element (SAA) and the switching element (SB) shown are turned off, the switching element (SD1) is turned on, and the switching element (SD2) is turned off. Accordingly, the counter electrode (ITO2) is charged with the reference potential (Vci).

Assuming that the H-level voltage (VcomH) of the common voltage (Vcom) is (Vci×2), a load charge current of the counter electrode (ITO2) during this period (1′) becomes ½.

### Period (3′)

In this period, in FIG. 20, the switching element (SA), the switching element (SAA) and the switching element (SB) shown are turned off, the switching element (SD1) is turned off, and the switching element (SD2) is turned on. Accordingly, the counter electrode (ITO2) is charged with the ground potential (GND). That is, the period (3′) is for GND driving and hence, a load charge current of the counter electrode (ITO2) becomes 0.

In this manner, in the circuit constitution shown in FIG. 20, it is possible to realize the reduction of power consumption during the period (1′) and the period (3′).

Here, during the charge redistributing period and during a period in which a clock (Clock) shown in FIG. 19 and FIG. 21 assumes a H level, a circuit for generating the common voltage (Vcom) inside the liquid crystal driving power source generating circuit 120 and the output part of the source driver 13 are completely separated from the liquid crystal display panel (PNL) and hence, by stopping the circuit for generating the common voltage (Vcom) inside the liquid crystal driving power source generating circuit 120 and the output part of the source driver 13 during this period, it is possible to further enhance the reduction of the power consumption.

Further, in FIG. 19 and FIG. 21, the clock (Clock) and a clock (Clock2) are signals inside a controller circuit 100 of a drive circuit (DRV).

Further, the optimum operation time of the above-mentioned operation differs depending on the load and the definition of the liquid crystal display panel (PNL). Accordingly, by providing a register function to the inside of the drive circuit (DRV) which realizes the above-mentioned operations, optimum values may be controlled for respective liquid crystal display panel (PNL) in use.

FIG. 22 shows one example of a register which sets times during periods (1′, 3′) and (1, 3) shown in FIG. 19 and FIG. 21.

EQWI shown in FIG. 22 is times during the periods (1′, 3′) and EQWI2 shown in FIG. 22 is times during the periods (1, 3), wherein based on set values of EQWI and EQWI2, the number of clocks can be changed as shown in FIG. 22.

Here, setting of times can use a clock from the MPU as the reference or a clock which is generated inside the controller circuit 100 in the drive circuit (DRV) as the reference.

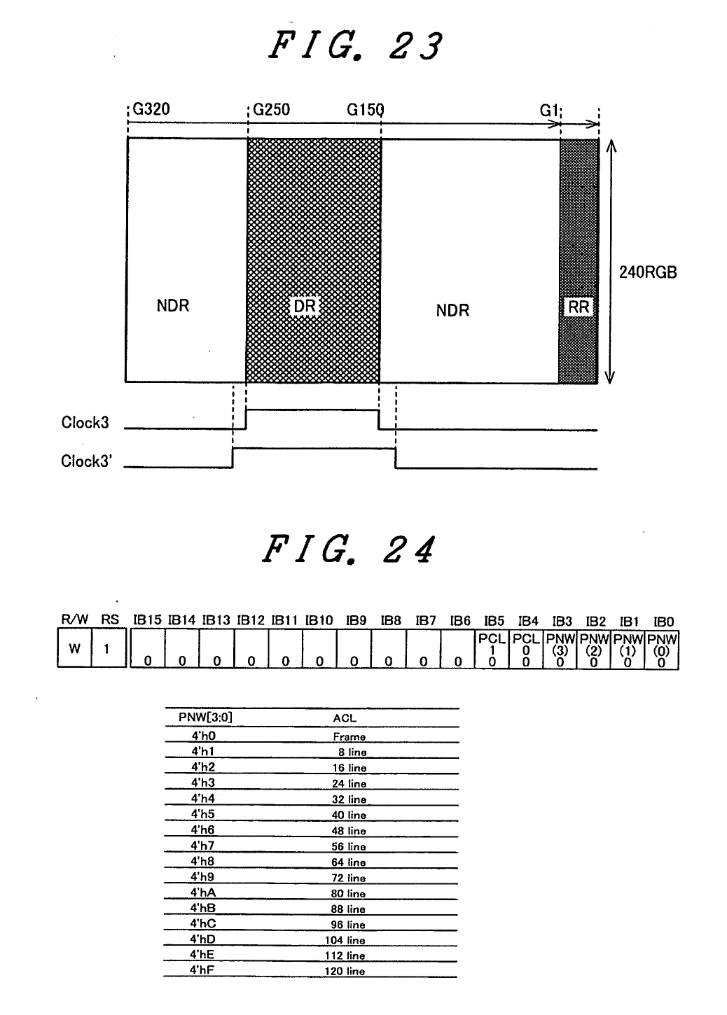

For example, in a mobile phone, there exists a state in which the whole screen of a liquid crystal display panel (PNL) is not used and a display is performed on only a portion of the screen such as a standby state, a talking state or a mail receiving state. However, the reduction of the power consumption can be achieved by narrowing a display area. One example of such a state is shown in FIG. 23.

However, when a DC voltage is applied to the liquid crystal, the liquid crystal is degraded. Accordingly, in the liquid crystal display device, it is always necessary to perform the AD driving and hence, a non-display region (NDR) shown in FIG. 23 also requires the AC driving.

The non-display region is usually white or black. Accordingly, it is possible to specify the writing of the non-display region to the writing in white or black. Such a specified motor is an eight color display mode (partial driving).

In FIG. 23, a clock (Clock3) which differentiates the display region (usual driving) and the non-display region (partial driving) is generated inside the controller circuit 100 of the drive circuit (DRV). The clock (Clock3) may be generated using the external clock as the reference in the same manner as the above-mentioned clocks (Clock, Clock2) or may be generated using a clock inside the controller circuit 100 of the drive circuit (DRV) as the reference.

It is needless to say that modes may not be changed exactly at a boundary between the display region DR and the non-display region and when the display region is usually driven as in the case of the clock (Clock3′), a mode changeover point may be roughly determined. It is possible to obtain a sufficient advantageous effect when the non-display region is wide. Further, a retrace period (RR) is also set to a low power consumption mode in the same manner

By delaying an inversion cycle of the common inversion driving method in the non-display region by this period, it is possible to achieve the reduction of the power consumption.

Usually, the display region is often inverted for every 1 line in the common inversion driving method by taking the image quality into consideration. However, the non-display region is a white matted screen or a black matted screen and hence, it is unnecessary to take an image quality into careful consideration. Accordingly, in the common inversion driving method, the non-display region may be inverted for every several lines or may be inverted for every 1 frame.

However, the optimum setting differs depending on the load and the definition of the liquid crystal display panel (PNL). Accordingly, by providing a register function to the inside of the drive circuit (DRV), the number of lines for inversion cycle of the common inversion driving method is set in the register or whether the partial driving in the non-display region is performed or not is set in the register whereby the optimum values may be controlled for respective liquid crystal display panel (PNL).

FIG. 24 shows one example of the register which sets the number of lines of the inversion cycle of the common inversion driving method.

In the example shown in FIG. 24, when PCL1-0 bit is 00, the non-display region is held in the usual driving (that is, the inversion cycle of the common inversion driving method being 1 line inversion in the same manner as the display region), and when PCL0=1, the inversion cycle of the common driving method of the non-display region is inverted for every n lines. The number of AC lines (ACL) is set using PNW bits. In an example shown in FIG. 24, the number of AC lines (ACL) is set for every 8 lines.

When PCL=1, it is determined whether the driving of the non-display region is performed by partial driving or not. Here, in the above-mentioned explanation, the explanation has been made with respect to the embodiments in which the present invention is applied to the TFT-type liquid crystal display module. However, the present invention is not limited to such embodiments and the present invention is applicable to an EL display device which includes organic EL elements.

Although the inventions made by inventors of the present inventions have been specifically explained based on embodiments, the present invention is not limited to the above-mentioned embodiments and various modifications can be made without departing from the gist of the present invention.

What is claimed is:

1. A display device comprising:
a display panel provided with a plurality of pixels each of which includes a pixel electrode;
a drive circuit which supplies a video signal to the respective pixels through video lines;
a counter electrode which faces pixel electrodes of the respective pixels; and
a power source circuit which applies a common voltage to the counter electrode, and is driven by alternately inverting an electric field direction between the pixel electrodes and the counter electrode for a predetermined cycle,
wherein the display device includes:
a first switching element which is connected between the counter electrode and the power source circuit,
a second switching element which is connected between the video line and the drive circuit, and
a third switching element and a fourth switching element which are connected in series between the video line and the counter electrode,
wherein the first switching element, the second switching element and the third switching element respectively include an n-type transistor element, and the fourth switching element is constituted of a p-type transistor element.

2. A display device according to claim 1, wherein in a first period of the predetermined cycle, the first switching element and the second switching element are turned off and the third switching element is turned on, and in a second period of the predetermined cycle, the first switching element and the second switching element are turned on and the third switching element is turned off.

3. A display device according to claim 1, wherein to the fourth switching element, a voltage equal to or larger than a highest voltage out of the common voltage is applied as a substrate potential, and a voltage which prevents a negative potential from being generated at a terminal which is connected to the third switching element is applied as a gate potential.

4. A display device according to claim 2, wherein to the fourth switching element, a voltage equal to or larger than a highest voltage out of the common voltage is applied as a substrate potential, and a voltage which prevents a negative potential from being generated at a terminal which is connected to the third switching element is applied as a gate potential.

5. A display device according to claim 1, wherein in a third period between the first period and the second period of the predetermined cycle, the first switching element, the second switching element and the third switching element are turned off, and in a third period of the predetermined cycle, a first intermediate voltage which is lower than a highest voltage out of the common voltage or a second intermediate voltage which is higher than a lowermost voltage out of the common voltage and is lower than the first intermediate voltage is alternately applied to the counter electrode.

6. A display device according to claim 2, wherein in a third period between the first period and the second period of the predetermined cycle, the first switching element, the second switching element and the third switching element are turned off, and in a third period of the predetermined cycle, a first intermediate voltage which is lower than a highest voltage out of the common voltage or a second intermediate voltage which is higher than a lowermost voltage out of the common voltage and is lower than the first intermediate voltage is alternately applied to the counter electrode.

7. A display device according to claim 3, wherein in a third period between the first period and the second period of the predetermined cycle, the first switching element, the second switching element and the third switching element are turned off, and in a third period of the predetermined cycle, a first intermediate voltage which is lower than a highest voltage out of the common voltage or a second intermediate voltage which is higher than a lowermost voltage out of the common voltage and is lower than the first intermediate voltage is alternately applied to the counter electrode.

8. A display device according to claim 1, wherein the predetermined cycle is changeable for every display region of the display panel.

9. A display device according to claim 2, wherein the predetermined cycle is changeable for every display region of the display panel.

10. A display device according to claim 3, wherein the predetermined cycle is changeable for every display region of the display panel.

11. A display device comprising:
a display panel provided with a plurality of pixels each of which includes a pixel electrode;
a drive circuit which supplies a video signal to the respective pixels through video lines;
a counter electrode which faces pixel electrodes of the respective pixels; and
a power source circuit which supplies a common voltage to the counter electrode, and is driven by alternately inverting an electric field direction between the pixel electrodes and the counter electrode for a predetermined cycle,
wherein the display device includes:
a first switching element which is connected between the counter electrode and the power source circuit,
a second switching element which is connected between the video line and the drive circuit, and
a third switching element which is connected between the video line and the counter electrode,
wherein the first switching element and the second switching element respectively include an n-type transistor element, and the third switching element is constituted of a p-type transistor element.

12. A display device according to claim 11, wherein in a first period of the predetermined cycle, the first switching element and the second switching element are turned off and the third switching element is turned on, and in a first period of the predetermined cycle, the first switching element and the second switching element are turned on and the third switching element is turned off.

13. A display device according to claim 11, wherein to the third switching element, a voltage equal to or larger than a highest voltage out of the common voltage is applied as a substrate potential.

14. A display device according to claim 12, wherein to the third switching element, a voltage equal to or larger than a highest voltage out of the common voltage is applied as a substrate potential.

15. A display device according to claim 11, wherein in a third period between the first period and the second period of the predetermined cycle, the first switching element, the second switching element and the third switching element are turned off, and in a third period of the predetermined cycle, a first intermediate voltage which is lower than a highest voltage out of the common voltage or a second intermediate voltage which is higher than a lowermost voltage out of the common voltage and is lower than the first intermediate voltage is alternately applied to the counter electrode.

16. A display device according to claim 12, wherein in a third period between the first period and the second period of the predetermined cycle, the first switching element, the second switching element and the third switching element are turned off, and in a third period of the predetermined cycle, a first intermediate voltage which is lower than a highest voltage out of the common voltage or a second intermediate voltage which is higher than a lowermost voltage out of the common voltage and is lower than the first intermediate voltage is alternately applied to the counter electrode.

17. A display device according to claim 11, wherein the predetermined cycle is changeable for every display region of the display panel.

18. A display device according to claim 12, wherein the predetermined cycle is changeable for every display region of the display panel.
